(19) United States
(12) Patent Application Publication
(10) Pub. No.: US 2026/0133473 A1
(43) Pub. Date: May 14, 2026

(54) ELECTRONIC DEVICE

(71) Applicant: CANON KABUSHIKI KAISHA, Tokyo (JP)

(72) Inventor: TAKUMA FUJIWARA, Kanagawa (JP)

(21) Appl. No.: 19/357,255

(22) Filed: Oct. 14, 2025

(30) Foreign Application Priority Data
Nov. 14, 2024 (JP) 2024-198867

(51) Int. Cl. G03B 13/34; H04N 23/63; H04N 23/67

(52) U.S. Cl. CPC G03B 13/34; H04N 23/632; H04N 23/675

(57) ABSTRACT

A electronic device according to the present disclosure includes a processor, and a memory storing a program which, when executed by the processor, causes the electronic device to execute acquisition processing of acquiring an image including a first image region captured via a first optical system and a second image region captured via a second optical system, execute display control processing of performing control such that the image is displayed, and execute control processing of performing control such that focus adjustment is performed in accordance with a focus adjustment instruction, wherein, in a case where the focus adjustment instruction is issued in a state where the second image region is displayed without displaying the first image region, in the control processing, control is performed such that focus adjustment of the first optical system and focus adjustment of the second optical system are performed.

### BACKGROUND

### Field of the Technology

The present disclosure relates to an electronic device, and particularly relates to adjustment of a focus difference of a plurality of optical systems.

### Description of the Related Art

There is a device capable of capturing two images having parallax at a time via two optical systems, that is, a right optical system (right lens) and a left optical system (left lens). In this device, it is necessary to adjust a focus difference between the right optical system and the left optical system. Hereinafter, an image captured through the right optical system is referred to as a right image, and an image captured through the left optical system is referred to as a left image.

JP 2024-52503 A discloses a technology of adjusting a focus difference between a right optical system and a left optical system by changing only a focus of the right optical system in accordance with a user operation.

However, the user may perform a user operation for focus adjustment with an intention of focus adjustment of only the left optical system or focus adjustment of both the right optical system and the left optical system instead of focus adjustment of only the right optical system. Thus, in the technology disclosed in JP 2024-52503 A, the focus adjustment unintended by the user may be performed.

### SUMMARY

The present disclosure provides a technology capable of suppressing focus adjustment unintended by a user.

A first electronic device according to the present disclosure includes a processor, and a memory storing a program which, when executed by the processor, causes the electronic device to execute acquisition processing of acquiring an image including a first image region captured via a first optical system and a second image region captured via a second optical system, execute display control processing of performing control such that the image is displayed, and execute control processing of performing control such that focus adjustment is performed in accordance with a focus adjustment instruction, wherein, in a case where the focus adjustment instruction is issued in a state where the second image region is displayed without displaying the first image region, in the control processing, control is performed such that focus adjustment of the first optical system and focus adjustment of the second optical system are performed.

A second electronic device according to the present disclosure includes a processor, and a memory storing a program which, when executed by the processor, causes the electronic device to execute acquisition processing of acquiring an image including a first image region captured via a first optical system and a second image region captured via a second optical system, execute display control processing of performing control such that the image is displayed, and execute control processing of performing control such that focus adjustment is performed in accordance with a focus adjustment instruction, wherein, in a case where the focus adjustment instruction is issued in a state where the second image region is displayed without displaying the first image region, in the control processing, control is performed such that focus adjustment of the first optical system is suppressed.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are external views of a camera.

FIG. 2 is a block diagram of the camera.

FIGS. 3A and 3C are schematic diagrams of a lens unit.

FIG. 3B is a schematic diagram of an adjustment mode change switch.

FIG. 4 is a flowchart of a camera operation.

FIGS. 5A to 5K are schematic diagrams of a display screen.

FIG. 6 is a flowchart of focus adjustment processing.

FIG. 7 is a schematic diagram of a focus guide.

FIG. 8 is a table representing a correspondence relationship among an adjustment mode, a display state, and the focus adjustment.

FIG. 9 is a table representing a correspondence relationship among the adjustment mode, the display state, and the focus adjustment.

### DESCRIPTION OF THE EMBODIMENTS

Hereinafter, embodiments of the present disclosure will be described with reference to the accompanying drawings.

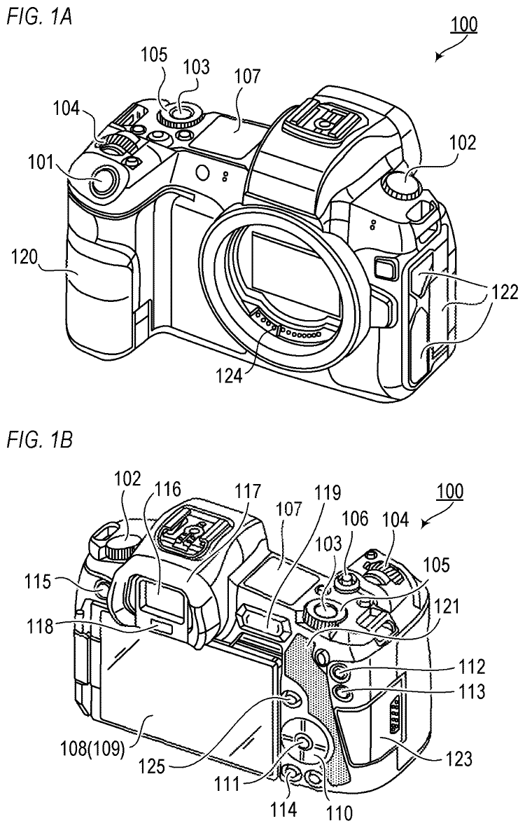

FIGS. 1A and 1B are external views illustrating an example of an external appearance of a digital camera (camera) 100 according to the present embodiment. FIG. 1A is a perspective view of the camera 100 as viewed from a front side, and FIG. 1B is a perspective view of the camera 100 as viewed from a back surface.

The camera 100 includes, on an upper surface thereof, a shutter button 101, a power switch 102, a mode selector switch 103, a main electronic dial 104, a sub-electronic dial 105, a movie button 106, and an outside viewfinder display unit 107. The shutter button 101 is an operation member for providing a shooting preparation instruction or a shooting instruction. The power switch 102 is an operation member for switching on or off of a power supply of the camera 100. The mode selector switch 103 is an operation member for switching among various modes. The main electronic dial 104 is a rotary operation member for changing setting values such as a shutter speed and an aperture value. The sub-electronic dial 105 is a rotary operation member for moving a selection frame (cursor) and feeding images. The movie button 106 is an operation member for providing an instruction to start or stop movie shooting (recording). The outside viewfinder display unit 107 displays various setting values such as a shutter speed and an aperture value.

The camera 100 includes, on a back surface, a display unit 108, a touch panel 109, a direction key 110, a SET button 111, an AE lock button 112, an enlargement button 113, a playback button 114, a menu button 115, an eyepiece portion 116, an eyepiece detection unit 118, and a touch bar 119. The display unit 108 displays images and various types of information. The touch panel 109 is an operation member for detecting a touch operation on a display surface (touch operation surface) of the display unit 108. The direction key 110 is an operation unit configured with keys that can be pressed up, down, left, and right (four direction keys). Processing corresponding to a position where the direction key 110 is pressed can be performed. The SET button 111 is an operation member to be pressed mainly when a selected item is determined. The AE lock button 112 is an operation member to be pressed when an exposure state is fixed in a shooting standby state. The enlargement button 113 is an operation member for switching on or off an enlargement mode in live view display (LV display) of a shooting mode. In a case where the enlargement mode is switched on, a live view image (LV image) is enlarged or reduced by operating the main electronic dial 104. In addition, the enlargement button 113 is used for enlarging a playback image or increasing an enlargement ratio in a playback mode. The playback button 114 is an operation member for switching between the shooting mode and the playback mode. In case of the shooting mode, according to the press of the playback button 114, the mode shifts to the playback mode, and thus, it is possible to display a latest image of images recorded in a recording medium 227 to be described below on the display unit 108.

The menu button 115 is an operation member to be pressed for displaying a menu screen, which enables various settings, on the display unit 108. A user can intuitively perform various settings by using the menu screen displayed on the display unit 108, the direction key 110, and the SET button 111. The eyepiece portion 116 is a portion in which the user approaches and looks through an eyepiece viewfinder (looking-through type viewfinder) 117 with the eyes. The user can visually confirm video displayed on an electronic view finder (EVF) 217 to be described below in the camera 100 through the eyepiece portion 116. The eyepiece detection unit 118 is a sensor for detecting whether or not the user approaches the eyepiece portion 116 (eyepiece viewfinder 117) with the eyes.

The touch bar 119 is a linear touch operation member (line touch sensor) that can receive a touch operation. The touch bar 119 is disposed at a position that enables a touch operation (touchable) with the thumb finger of the right hand in a state where a grip portion 120 is gripped with the right hand (a state where the grip portion 120 is gripped with the little finger, the ring finger, and the middle finger of the right hand) such that the shutter button 101 can be pressed by the index finger of the right hand. That is, the touch bar 119 can be operated in a state where the user approaches to the eyepiece viewfinder 117 with the eyes, looks through the eyepiece portion 116, and holds up the camera 100 so as to be able to press the shutter button 101 at any time (shooting orientation). The touch bar 119 can receive a tapping operation on the touch bar 119 (an operation of touching the touch bar and releasing the touch bar without moving a touch position within a predetermined period of time), a sliding operation to the left or right (an operation of touching the touch bar and then moving the touch position while keeping the touch), and the like. The touch bar 119 is an operation member that is different from the touch panel 109 and does not have a display function. The touch bar 119 functions as, for example, a multi-function bar (M-Fn bar) to which various functions can be allocated.

In addition, the camera 100 has a grip portion 120, a thumb rest portion 121, a terminal cover 122, a lid 123, a communication terminal 124, and a display switching button 125. The grip portion 120 is a holding portion formed in a shape easy for the user to grip with the right hand when the user holds the camera 100. The shutter button 101 and the main electronic dial 104 are arranged at positions that allow the user to operate the shutter button 101 and the main electronic dial 104 with the index finger of the right hand in a state where the user holds the camera 100 while gripping the grip portion 120 with the little finger, the ring finger, and the middle finger of the right hand. In addition, in a similar state, the sub-electronic dial 105 and the touch bar 119 are arranged at positions where the user can operate the sub-electronic dial 105 and the touch bar 119 with the thumb finger of the right hand. The thumb rest portion 121 (thumb standby position) is a grip portion provided at a place where it is easy for the user to place the thumb finger of the right hand that grips the grip portion 120 on the back surface of the camera 100 in a state where any of the operation members is not operated. The thumb rest portion 121 is configured with a rubber member for enhancing holding power (gripping feeling). The terminal cover 122 protects connectors such as connection cables for connecting the camera 100 to external devices (external equipment). The lid 123 closes a slot for storing the recording medium 227 to be described below, to protect the recording medium 227 and the slot. The communication terminal 124 is a terminal for communication with a lens unit (a lens unit 200, a lens unit 300, or the like to be described below) attachable to and detachable from the camera 100. The display switching button 125 is an operation member for switching the display of the display unit 108.

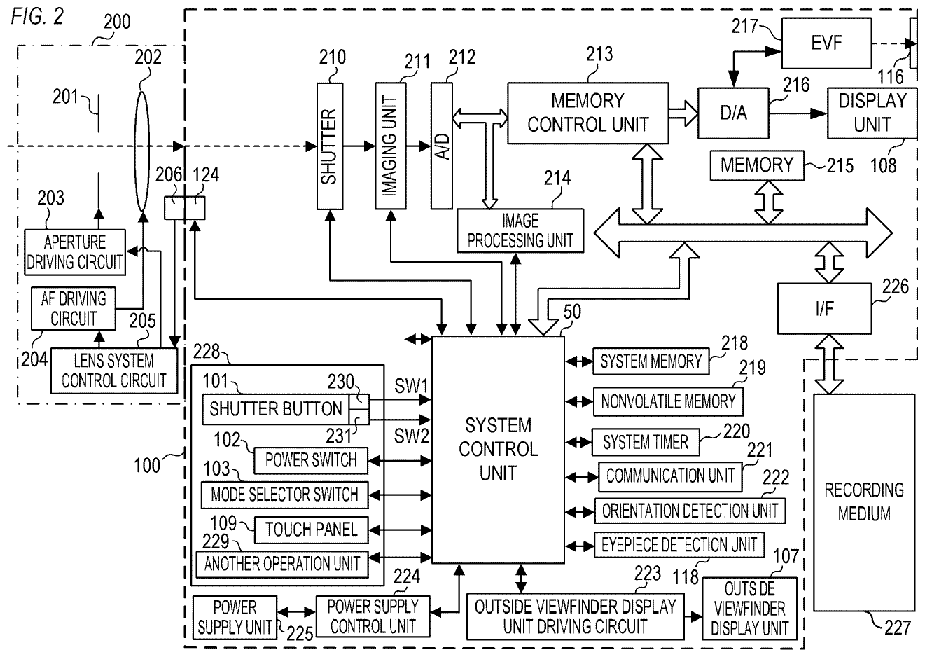

FIG. 2 is a block diagram illustrating an example of a configuration of the camera 100. Note that, in FIG. 2, the same components as those in FIGS. 1A and 1B are denoted by the same reference numerals as in FIGS. 1A and 1B, and description of the components is appropriately omitted. In FIG. 2, the lens unit 200 is mounted to the camera 100.

First, the lens unit 200 is described. The lens unit 200 is a type of an interchangeable lens unit (interchangeable lens) that is attachable to and detachable from the camera 100. The lens unit 200 is a single-lens unit (single lens) and is an example of a normal lens unit. The lens unit 200 includes an aperture 201, a lens 202, an aperture driving circuit 203, an autofocus (AF) driving circuit 204, a lens system control circuit 205, and a communication terminal 206, and the like.

The aperture 201 is configured so that an aperture diameter is adjustable. The lens 202 is configured with a plurality of lenses. The aperture driving circuit 203 adjusts a quantity of light by controlling the aperture diameter of the aperture 201. The AF driving circuit 204 adjusts the focus by driving the lens 202. The lens system control circuit 205 controls the aperture driving circuit 203, the AF driving circuit 204, and the like based on instructions from a system control unit 50 to be described below. The lens system control circuit 205 controls the aperture 201 via the aperture driving circuit 203 and adjusts the focus by changing a position of the lens 202 via the AF driving circuit 204. The lens system control circuit 205 can communicate with the camera 100. Specifically, the communication is performed via the communication terminal 206 of the lens unit 200 and the communication terminal 124 of the camera 100. The communication terminal 206 is a terminal that enables the lens unit 200 to communicate with the camera 100 side.

Next, the camera 100 is described. The camera 100 includes a shutter 210, an imaging unit 211, an A/D converter 212, a memory control unit 213, an image processing unit 214, a memory 215, a D/A converter 216, the EVF 217, the display unit 108, and the system control unit 50.

The shutter 210 is a focal plane shutter that can freely control an exposure time of the imaging unit 211 based on an instruction of the system control unit 50. The imaging unit 211 is an imaging element (image sensor) configured with a CCD, a CMOS element, or the like that converts an optical image into an electrical signal. The imaging unit 211 may include an imaging-surface phase-difference sensor for outputting defocus-amount information to the system control unit 50. The A/D converter 212 converts an analog signal output from the imaging unit 211 into a digital signal. The image processing unit 214 performs predetermined processing (pixel interpolation, resizing processing such as reduction, color conversion processing, and the like) on data from the A/D converter 212 or data from the memory control unit 213. In addition, the image processing unit 214 performs predetermined arithmetic processing by using captured image data, and the system control unit 50 performs exposure control and distance measurement control based on the obtained result of arithmetic processing. By this processing, through-the-lens (TTL)-type AF processing, auto exposure (AE) processing, EF (flash pre-flash) processing, and the like are performed. Furthermore, the image processing unit 214 performs predetermined arithmetic processing by using the captured image data, and the system control unit 50 performs TTL-type auto white balance (AWB) processing based on the obtained result of arithmetic processing.

The image data from the A/D converter 212 is written into the memory 215 via the image processing unit 214 and the memory control unit 213. Alternatively, the image data from the A/D converter 212 is written into the memory 215 via the memory control unit 213 without the intervention of the image processing unit 214. The memory 215 stores the image data that is obtained by the imaging unit 211 and is converted into digital data by the A/D converter 212 and image data to be displayed on the display unit 108 or the EVF 217. The memory 215 has a storage capacity sufficient to store a predetermined number of still images and a predetermined length of moving images and voice. In addition, the memory 215 also serves as a memory for displaying an image (video memory).

The D/A converter 216 converts image data for display stored in the memory 215 into an analog signal and supplies the analog signal to the display unit 108 or the EVF 217. Accordingly, the image data for display written into the memory 215 is displayed on the display unit 108 or the EVF 217 via the D/A converter 216. The display unit 108 and the EVF 217 provide display in response to the analog signal from the D/A converter 216. The display unit 108 and the EVF 217 are, for example, LCD or organic EL displays. The digital signal that is A/D converted by the A/D converter 212 and is accumulated in the memory 215 is converted into the analog signal in the D/A converter 216, and the analog signal is sequentially transferred to and displayed on the display unit 108 or the EVF 217, so that live-view display is performed.

The system control unit 50 is a control unit including at least one processor and/or at least one circuit. That is, the system control unit 50 may be a processor, a circuit, or a combination of a processor and a circuit. The system control unit 50 controls the overall camera 100. The system control unit 50 implements the processing of flowcharts to be described below, by executing programs recorded in a nonvolatile memory 219. In addition, the system control unit 50 also performs display control by controlling the memory 215, the D/A converter 216, the display unit 108, the EVF 217, and the like.

In addition, the camera 100 includes a system memory 218, the nonvolatile memory 219, a system timer 220, a communication unit 221, an orientation detection unit 222, and the eyepiece detection unit 118.

For example, a RAM is used as the system memory 218. In the system memory 218, constants, variables, and programs read from the nonvolatile memory 219 for an operation of the system control unit 50 are loaded. The nonvolatile memory 219 is an electrically erasable and recordable memory. For example, an EEPROM is used as the nonvolatile memory 219. In the nonvolatile memory 219, constants, programs, and the like for the operation of the system control unit 50 are recorded. The program as used herein includes programs for performing the flowcharts to be described below. The system timer 220 is a timer unit that counts time used for various types of control and time of a built-in clock. The communication unit 221 transmits and receives a video signal and a voice signal to and from external device connected wirelessly or via a wired cable. The communication unit 221 is also connectable to a wireless local area network (LAN) and the Internet. In addition, the communication unit 221 can communicate with external device also via Bluetooth (registered trademark) and Bluetooth Low Energy. The communication unit 221 can transmit an image captured by the imaging unit 211 (including a live image) and an image recorded in the recording medium 227 and can receive an image and other various types of information from external device. The orientation detection unit 222 is an orientation detection sensor that detects an orientation of the camera 100 with respect to a direction of gravity. Based on the orientation detected by the orientation detection unit 222, whether an image shot by the imaging unit 211 is an image shot with the camera 100 held in a horizontal position or held in a vertical position can be determined. The system control unit 50 can add orientation information in accordance with the orientation detected by the orientation detection unit 222 to an image file of the image shot by the imaging unit 211 and can rotate the image corresponding to the detected orientation. For example, an acceleration sensor or a gyro sensor can be used for the orientation detection unit 222. It is possible to also detect the movement of the camera 100 (whether it is panning, tilting, lifting, stationary, or the like) by using the orientation detection unit 222.

The eyepiece detection unit 118 can detect that an object approaches the eyepiece portion 116 (eyepiece viewfinder 117). For example, an infrared proximity sensor can be used as the eyepiece detection unit 118. In a case where the object approaches, infrared light emitted from a light-emitting portion of the eyepiece detection unit 118 is reflected on the object and is received by a light-receiving portion of the infrared proximity sensor. A distance from the eyepiece portion 116 to the object can be determined according to the amount of received infrared light. In this way, the eyepiece detection unit 118 performs eyepiece detection for detecting a distance between the eyepiece portion 116 and the object approaching the eyepiece portion 116. The eyepiece detection unit 118 is an eyepiece detection sensor that detects approach (eye approach) and separation (eye separation) of an eye (object) to and from the eyepiece portion 116. In a case where the object approaching the eyepiece portion 116 within a predetermined distance is detected in a non-eye approach state (non-approach state), the eyepiece detection unit 118 detects that the eye approaches. Meanwhile, in a case where the object of which the approach is detected is separated by a predetermined distance or longer in an eye approach state (approach state), the eyepiece detection unit 118 detects that the eye is separated. A threshold value for detecting the eye approach and a threshold value for detecting the eye separation may be different for providing, for example, a hysteresis. In addition, after the eye approach is detected, the eye approach state is assumed until the eye separation is detected. After the eye separation is detected, the non-eye approach state is assumed until the eye approach is detected. The system control unit 50 switches between display (display state) and non-display (non-display state) of each of the display unit 108 and the EVF 217 in accordance with the state detected by the eyepiece detection unit 118. Specifically, in a case where at least the shooting standby state is established, and a switching setting for a display destination is set to automatic switching, the display destination is set as the display unit 108, and the display is turned on, while the EVF 217 is set to non-display during the non-eye approach state. In addition, during the eye approach state, the EVF 217 is set as the display destination, and the display is turned on, while the display unit 108 is set to non-display. Note that the eyepiece detection unit 118 is not limited to the infrared proximity sensor, and other sensors may be used as the eyepiece detection unit 118 as long as the sensors can detect the state which can be regarded as the eye approach.

In addition, the camera 100 also includes the outside viewfinder display unit 107, an outside viewfinder display unit driving circuit 223, a power supply control unit 224, a power supply unit 225, a recording medium I/F 226, and an operation unit 228.

The outside viewfinder display unit 107 is driven by the outside viewfinder display unit driving circuit 223 and displays various setting values for the camera 100 such as a shutter speed and an aperture value. The power supply control unit 224 is configured with a battery detection circuit, a DC-DC converter, a switch circuit that switches a block to be energized, and the like and detects whether or not a battery is mounted, a type of battery, a remaining battery level, and the like. In addition, the power supply control unit 224 controls the DC-DC converter based on the detection result and an instruction from the system control unit 50 and supplies a required voltage to portions including the recording medium 227 for a necessary period of time. The power supply unit 225 is a primary battery such as alkaline and lithium batteries, a secondary battery such as NiCd, NiMH, and Li batteries, an AC adapter, or the like. The recording medium I/F 226 is an interface to the recording medium 227 such as a memory card and a hard disk. The recording medium 227 is a memory card for recording shot images, and the like and is configured with a semiconductor memory, a magnetic disk, and the like. The recording medium 227 may be attachable to and detachable from the camera 100 or may also be embedded in the camera 100.

The operation unit 228 is an input unit that receives an operation from the user (user operation) and is used for inputting various instructions to the system control unit 50. The operation unit 228 includes the shutter button 101, the power switch 102, the mode selector switch 103, the touch panel 109, and another operation unit 229. The other operation unit 229 includes the main electronic dial 104, the sub-electronic dial 105, the movie button 106, the direction key 110, the SET button 111, and the AE lock button 112. Furthermore, the other operation unit 229 includes the enlargement button 113, the playback button 114, the menu button 115, the touch bar 119, and the display switching button 125.

The shutter button 101 includes a first shutter switch 230 and a second shutter switch 231. The first shutter switch 230 is turned on in the middle of the operation of the shutter button 101 in response to so-called half-press (shooting preparation instruction) and outputs a first shutter switch signal SW1. The system control unit 50 starts shooting preparation processing such as AF processing, AE processing, AWB processing, and EF processing in accordance with the first shutter switch signal SW1. The second shutter switch 231 is turned on at the completion of the operation of the shutter button 101 in response to so-called full-press (shooting instruction) and outputs a second shutter switch signal SW2. In accordance with the second shutter switch signal SW2, the system control unit 50 starts a sequence of shooting processing involving reading of a signal from the imaging unit 211, generating an image file including the shot image, and writing of the generated image file into the recording medium 227.

The mode selector switch 103 switches the operation mode of the system control unit 50 to any one of a still image shooting mode, a movie shooting mode, and a playback mode. Examples of the modes of the still image shooting mode include an auto shooting mode, an auto scene-determination mode, a manual mode, an aperture-priority mode (Av mode), a shutter-speed priority mode (Tv mode), and a program AE mode (P mode). In addition, the mode also includes various scene modes which have shooting settings for different shooting scenes, a custom mode, and the like. The user can directly switch the mode to any of the above-described shooting modes with the mode selector switch 103. Alternatively, the user can temporarily switch a screen to a list screen of the shooting modes with the mode selector switch 103 and then selectively switch the mode to any of the plurality of displayed modes with the operation unit 228. Similarly, the movie shooting mode may include a plurality of modes.

The touch panel 109 is a touch sensor for detecting various touch operations on the display surface of the display unit 108 (the operation surface of the touch panel 109). The touch panel 109 and the display unit 108 can be integrally configured. For example, the touch panel 109 is attached to an upper layer of the display surface of the display unit 108 such that a transmittance of light does not hinder the display on the display unit 108. Furthermore, input coordinates on the touch panel 109 and display coordinates on the display surface of the display unit 108 are associated with each other, thereby configuring a graphical user interface (GUI) such that the user can directly operate a screen displayed on the display unit 108. The touch panel 109 can use any of various methods including resistive film, capacitive, surface acoustic wave, infrared, electromagnetic induction, image recognition, optical sensor methods, and the like. Depending on the methods, there is a method of detecting a touch based on contact with the touch panel 109 and a method of detecting a touch based on approach of a finger or a pen to the touch panel 109, but any method may be adopted.

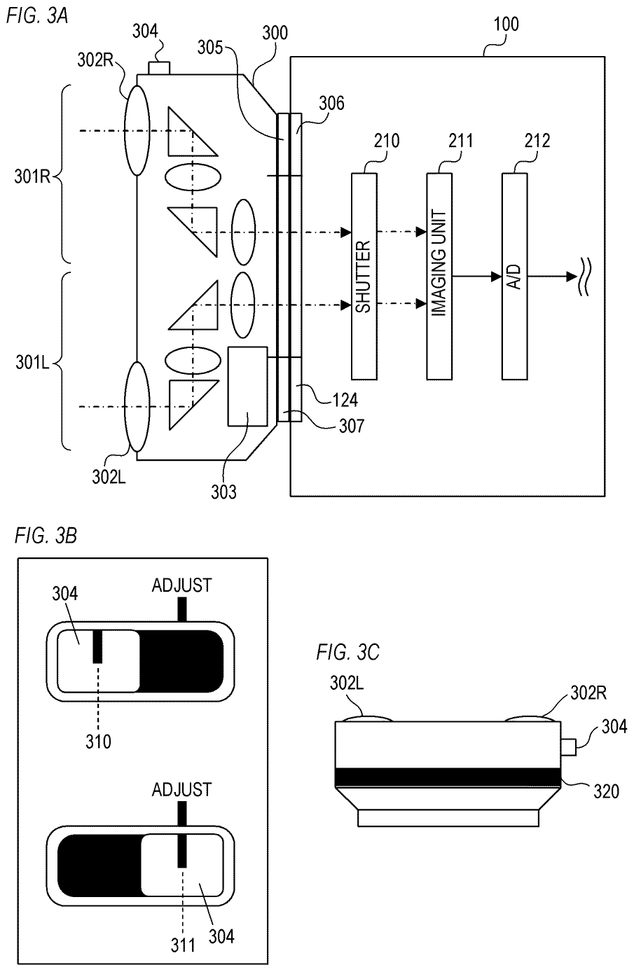

FIG. 3A is a schematic diagram illustrating an example of a configuration of the lens unit 300. FIG. 3A illustrates a state where the lens unit 300 is mounted to the camera 100. Note that, in FIG. 3A, the same components as those described in FIG. 2 are denoted by the same reference numerals as in FIG. 2, and the description thereof is appropriately omitted.

The lens unit 300 is a type of an interchangeable lens unit attachable to and detachable from the camera 100. The lens unit 300 is a dual-lens unit (dual-lens) capable of capturing a right image and a left image having a parallax. The lens unit 300 includes two optical systems, and each of the two optical systems can capture an image in a range at a wide viewing angle of about 180 degrees. Specifically, each of the two optical systems of the lens unit 300 can capture an image of an object corresponding to a field of view (angle of view) of 180 degrees in a left-to-right direction (horizontal angle, azimuth angle, yaw angle) and 180 degrees in an up-and-down direction (vertical angle, elevation angle, pitch angle). That is, each of the two optical systems can capture an image in a front hemispherical range.

The lens unit 300 includes a right optical system 301R including a plurality of lenses, reflecting mirrors, and the like, a left optical system 301L including a plurality of lenses, reflecting mirrors, and the like, and a lens system control circuit 303. The right optical system 301R includes a lens 302R disposed near the object, and the left optical system 301L includes a lens 302L disposed near the object. The lens 302R and the lens 302L are oriented in the same direction and optical axes thereof are substantially parallel to each other.

The lens unit 300 is a dual-lens unit (VR180 lens unit) for obtaining a VR180 image that is one of virtual reality (VR) image formats capable of binocular stereoscopic vision. In the lens unit 300, each of the right optical system 301R and the left optical system 301L includes a fish-eye lens capable of capturing a range of about 180 degrees. Note that, the range that can be captured by the lens of each of the right optical system 301R and the left optical system 301L may be a range of about 160 degrees narrower than the range of 180 degrees. The lens unit 300 can form a right image formed through the right optical system 301R and a left image formed through the left optical system 301L on one or two imaging elements of the camera to which the lens unit 300 is mounted. In the camera 100, the right image and the left image are formed on one imaging element (image sensor), and one image (binocular image) in which a right image region (area of right image) and a left image region (area of left image) are arranged side by side is generated.

The lens unit 300 includes an adjustment mode change switch 304. The user can activate one of a focus adjustment mode and a focus difference adjustment mode by switching a position of the adjustment mode change switch 304 between a position 310 and a position 311 illustrated in FIG. 3B. In a case where the adjustment mode change switch 304 is at the position 310, the focus adjustment mode becomes active, and in a case where the adjustment mode change switch 304 is at the position 311, the focus difference adjustment mode becomes active.

The lens unit 300 is mounted to the camera 100 via a lens mount portion 305 and a camera mount portion 306 of the camera 100. In this manner, the system control unit 50 of the camera 100 and the lens system control circuit 303 of the lens unit 300 are electrically connected to each other via the communication terminal 124 of the camera 100 and a communication terminal 307 of the lens unit 300.

In FIG. 3A, the right image formed through the right optical system 301R and the left image formed through the left optical system 301L are formed side by side in the imaging unit 211 of the camera 100. In other words, the right optical system 301R and the left optical system 301L form two optical images (object images) in the two regions of one imaging element (image sensor). The imaging unit 211 converts the formed optical image (optical signal) into an analog electrical signal. By using the lens unit 300 in this manner, one image including two image regions having a parallax can be acquired from two places (optical systems), that is, the right optical system 301R and the left optical system 301L. By dividing the acquired image into an image for a left eye and an image for a right eye and providing the images in VR display, the user can view a stereoscopic VR image about in a 180-degree range. In other words, the user can view a VR 180 image stereoscopically.

As illustrated in FIG. 3C, the lens unit 300 includes a focus ring 320 that performs focus adjustment. The focus ring 320 is exposed on an outer periphery of the lens unit 300, and the user can perform focus adjustment by rotating the focus ring 320. The focus adjustment is performed by driving one or both of the right optical system 301R and the left optical system 301L in accordance with the adjustment mode of the lens unit 300.

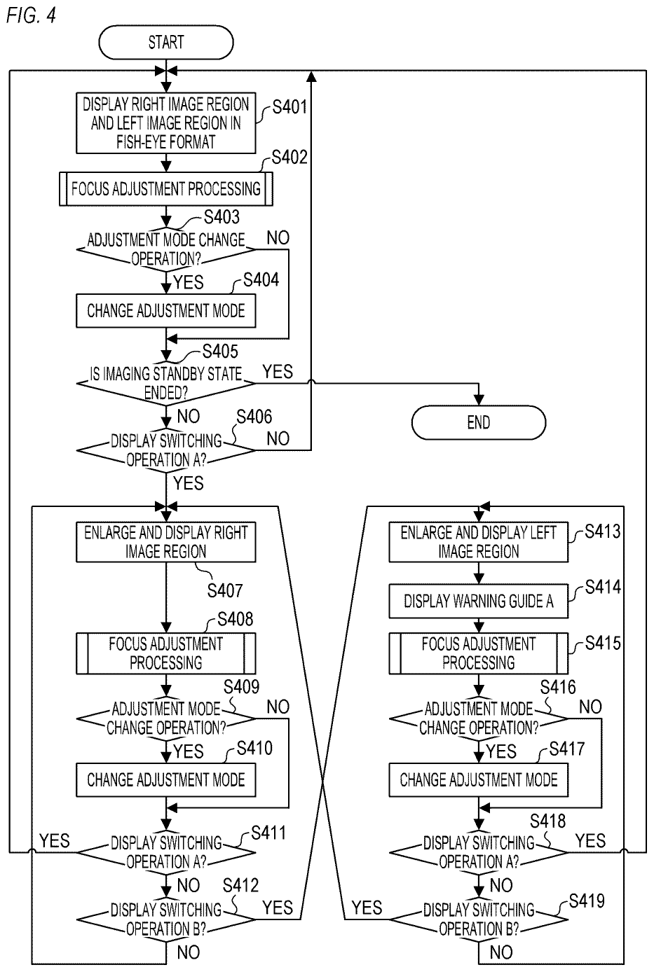

FIG. 4 is a flowchart illustrating an example of an operation of the camera 100. The operation is implemented by loading a program recorded in the nonvolatile memory 219 into the system memory 218 and executing the program by the system control unit 50. The operation of FIG. 4 is performed in the shooting standby state of the camera 100. For example, when the camera 100 is activated in the shooting mode or the shooting mode is set to the camera 100, the operation of FIG. 4 is started.

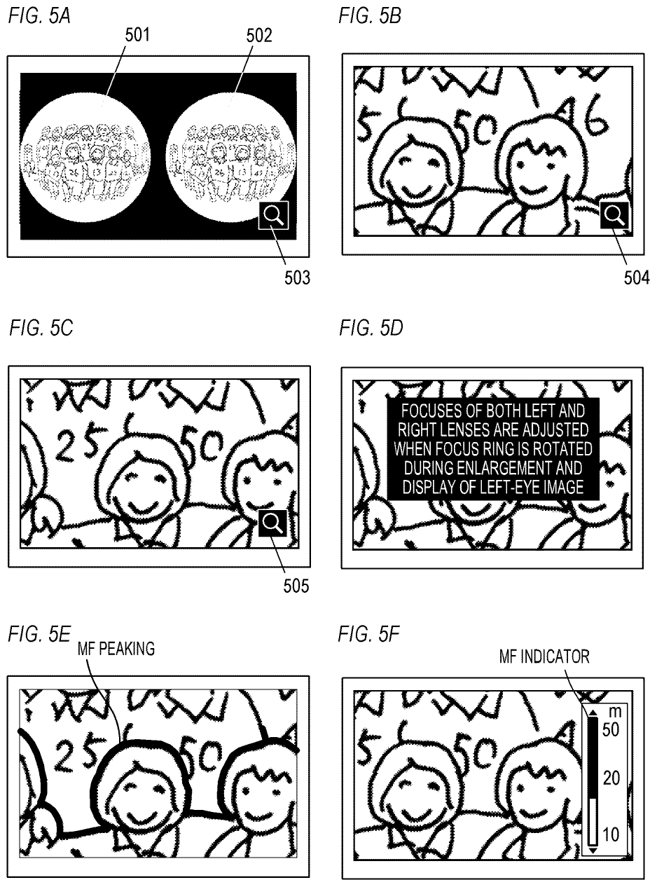

In step S401, the system control unit 50 displays a right image region captured via the right optical system 301R and a left image region captured via the left optical system 301L on the display unit 108 in a fish-eye format. FIG. 5A illustrates an example of a display image (display screen) in step S401. The right image region is vertically and horizontally reversed and formed on the right half of an image forming surface of the imaging unit 211, and the left image region is vertically and horizontally reversed and formed on the left half of the image forming surface of the imaging unit 211. The obtained image is vertically and horizontally reversed and displayed on the display unit 108. Thus, in FIG. 5A, a right image region 501 is arranged on a left side, and a left image region 502 is arranged on a right side.

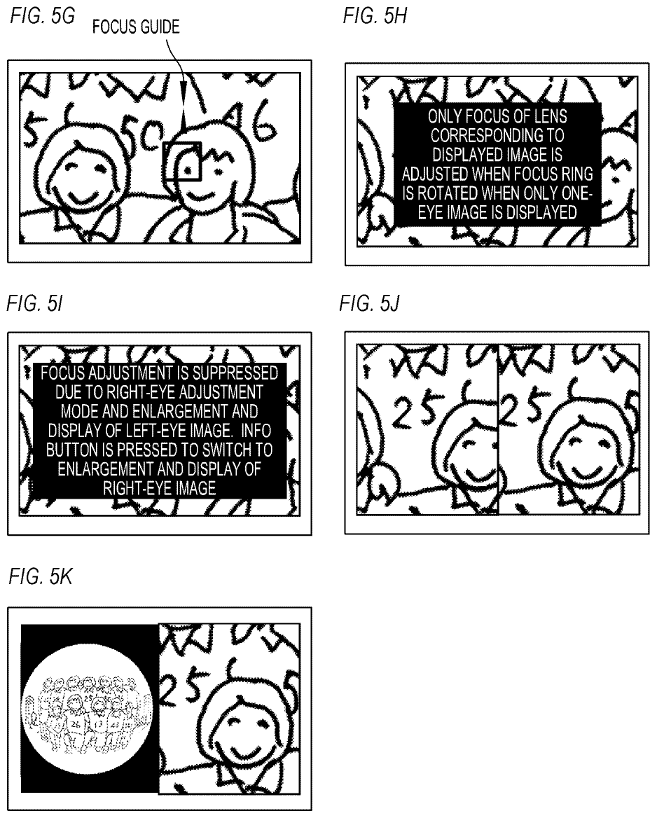

In step S402, the system control unit 50 executes focus adjustment processing (processing related to focus adjustment). Details of the focus adjustment processing will be described later with reference to FIG. 6.

In step S403, the system control unit 50 determines whether or not an adjustment mode change operation is performed. In a case where the system control unit 50 determines that the adjustment mode change operation is performed, the processing proceeds to step S404, and otherwise, the processing proceeds to step S405. The adjustment mode change operation is, for example, an operation of switching the position of the adjustment mode change switch 304.

In step S404, the system control unit 50 changes the adjustment mode.

In step S405, the system control unit 50 determines whether or not to end the shooting standby state (display of shooting standby screen or shooting mode). In a case where the system control unit 50 determines to end the shooting standby state, the operation of FIG. 4 is ended, and otherwise, the processing proceeds to step S406.

In step S406, the system control unit 50 determines whether or not a display switching operation A is performed. In a case where the system control unit 50 determines that the display switching operation A is performed, the processing proceeds to step S407, and otherwise, the processing proceeds to step S401. The display switching operation A is, for example, an operation of touching an enlargement touch button 503 illustrated in FIG. 5A.

In step S407, the system control unit 50 enlarges and displays the right image region on the display unit 108. FIG. 5B illustrates an example of the display image (display screen) in step S407. In FIG. 5B, the enlargement and display of the right image region are performed. In FIG. 5B, an image obtained by perspective projection transformation of a part of the right image region in the fish-eye format is displayed as an enlarged image of the right image region. In FIG. 5B, the left image region is not displayed.

In step S408, the system control unit 50 executes focus adjustment processing. Details of the focus adjustment processing will be described later with reference to FIG. 6.

In step S409, the system control unit 50 determines whether or not the adjustment mode change operation is performed. In a case where the system control unit 50 determines that the adjustment mode change operation is performed, the processing proceeds to step S410, and otherwise, the processing proceeds to step S411.

In step S410, the system control unit 50 changes the adjustment mode.

In step S411, the system control unit 50 determines whether or not the display switching operation A is performed. In a case where the system control unit 50 determines that the display switching operation A is performed, the processing proceeds to step S401, and otherwise, the processing proceeds to step S412. The display switching operation A is, for example, an operation of touching an enlargement touch button 504 illustrated in FIG. 5B.

In step S412, the system control unit 50 determines whether or not a display switching operation B is performed. In a case where the system control unit 50 determines that the display switching operation B is performed, the processing proceeds to step S413, and otherwise, the processing proceeds to step S407. The display switching operation B is, for example, an operation of pressing the display switching button 125.

In step S413, the system control unit 50 enlarges and displays the left image region on the display unit 108. FIG. 5C illustrates an example of the display image (display screen) in step S413. In FIG. 5C, the enlargement and display of the left image region are performed. In FIG. 5C, an image obtained by perspective projection transformation of a part of the left image region in the fish-eye format is displayed as an enlarged image of the left image region. In FIG. 5C, the right image region is not displayed.

In step S414, the system control unit 50 displays a warning guide A on the display unit 108. FIG. 5D illustrates an example of the warning guide A. The warning guide A in FIG. 5D is a guide indicating that both the focus adjustment of the right optical system 301R and the focus adjustment of the left optical system 301L are performed in accordance with the rotation of the focus ring 320 during the enlargement and display of the left image region. The focus adjustment of the right optical system 301R is performed by driving the right optical system 301R, and the focus adjustment of the left optical system 301L is performed by driving the left optical system 301L.

Here, a case where only the focus adjustment of the right optical system 301R is performed in accordance with the rotation of the focus ring 320 is considered. For example, the user rotates the focus ring 320 while viewing the right image region and the left image region, and changes only a focus position of the right optical system 301R so as to focus on the same object in the right image region and the left image region.

However, the display unit 108 of the camera 100 may be small, and in a state where both the right image region and the left image region are displayed, it may be difficult to easily confirm details (such as a focusing degree) of the right image region and the left image region. Thus, the user may check not only a state where both the right image region and the left image region are displayed, but also a state where a part of the right image region is enlarged and displayed on the entire screen and a state where a part of the left image region is enlarged and displayed on the entire screen.

Then, in a state where a part of the left image region is enlarged and displayed on the entire screen (state where the right image region is not displayed), since the user cannot confirm the right image region, there is a low possibility that the user wants to perform only the focus adjustment of the right optical system 301R. In such a state, for example, the user wants to perform both the focus adjustment of the right optical system 301R and the focus adjustment of the left optical system 301L, or only the focus adjustment of the left optical system 301L.

Thus, in the configuration in which only the focus adjustment of the right optical system 301R is performed in accordance with the rotation of the focus ring 320, focus adjustment unintended by the user may be performed.

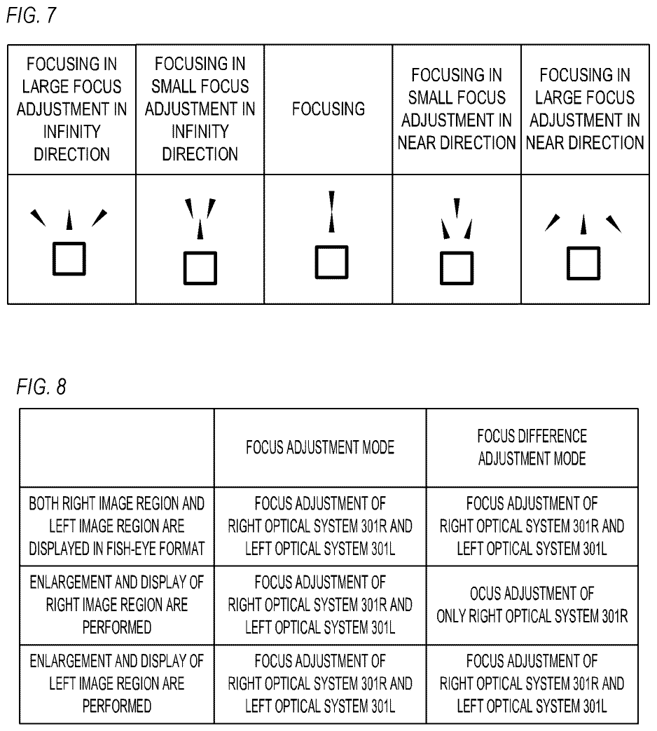

Therefore, in the present embodiment, as illustrated in FIG. 8, the focus adjustment is changed in accordance with whether or not the right image region is being displayed (whether or not the left image region is being enlarged and displayed) in the focus difference adjustment mode. In order to suppress the user's confusion due to such a change in focus adjustment, the warning guide A is displayed.

The warning guide A may be displayed at the start of enlarging and displaying the left image region, and may not be displayed when a predetermined time has elapsed from the start of display of the warning guide A. The warning guide A may not be displayed in accordance with an operation such as a user's touch. Although the warning guide A in FIG. 5D is text, other items such as an icon may be displayed as the warning guide A.

The description refers back to FIG. 4. In step S415, the system control unit 50 executes the focus adjustment processing. Details of the focus adjustment processing will be described later with reference to FIG. 6.

In step S416, the system control unit 50 determines whether or not the adjustment mode change operation is performed. In a case where the system control unit 50 determines that the adjustment mode change operation is performed, the processing proceeds to step S417, and otherwise, the processing proceeds to step S418.

In step S417, the system control unit 50 changes the adjustment mode.

In step S418, the system control unit 50 determines whether or not the display switching operation A is performed. In a case where the system control unit 50 determines that the display switching operation A is performed, the processing proceeds to step S401, and otherwise, the processing proceeds to step S419. The display switching operation A is, for example, an operation of touching an enlargement touch button 505 illustrated in FIG. 5C.

In step S419, the system control unit 50 determines whether or not the display switching operation B is performed. In a case where the system control unit 50 determines that the display switching operation B is performed, the processing proceeds to step S407, and otherwise, the processing proceeds to step S413. The display switching operation B is, for example, an operation of pressing the display switching button 125.

FIG. 6 is a flowchart illustrating an example of the focus adjustment processing performed in steps S402, S408, and S415 in FIG. 4.

In step S601, the system control unit 50 determines whether or not an ON operation of an MF peaking display function is performed. In a case where the system control unit 50 determines that the ON operation of the MF peaking display function is performed, the processing proceeds to step S602, and otherwise, the processing proceeds to step S603.

In step S602, the system control unit 50 sets the MF peaking display function to be ON (enabled). The MF peaking display function is a function of performing MF peaking display. The MF peaking display is display related to the focus position of the optical system, and as illustrated in FIG. 5E, the MF peaking display is a display that emphasizes a contour of a focusing region. In the MF peaking display, the contour may be emphasized by superimposing a contour line (another image) on the captured image, or the contour may be emphasized by changing a pixel value of the captured image. The contour is emphasized with a predetermined color such as red or green, for example.

In step S603, the system control unit 50 determines whether or not an ON operation of a MF indicator display function is performed. In a case where the system control unit 50 determines that the ON operation of the MF indicator display function is performed, the processing proceeds to step S604, and otherwise, the processing proceeds to step S605.

In step S604, system control unit 50 sets the MF indicator display function to be ON (enabled). The MF indicator display function is a function of performing MF indicator display. The MF indicator display is display related to the focus position of the optical system, and is a display of an item (MF indicator) indicating a distance from the camera 100 to the focus position of the optical system as illustrated in FIG. 5F. The MF indicator is superimposed on the captured image.

In step S605, the system control unit 50 determines whether or not an ON operation of a focus guide display function is performed. In a case where the system control unit 50 determines that the ON operation of the focus guide display function is performed, the processing proceeds to step S606, and otherwise, the processing proceeds to step S607.

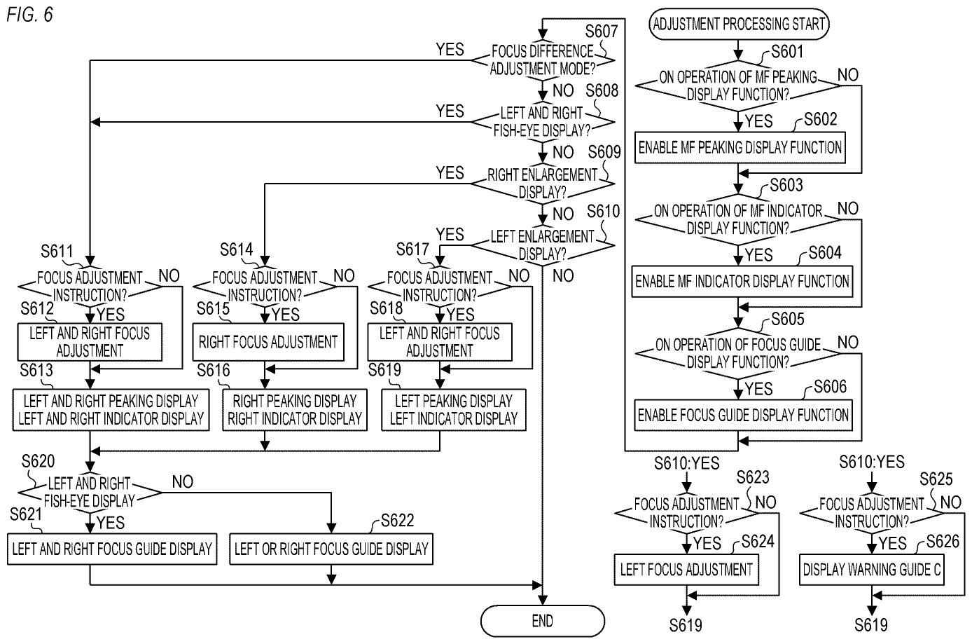

In step S606, the system control unit 50 sets the focus guide display function to be ON (enabled). The focus guide display function is a function of performing focus guide display. The focus guide display is display related to the focus position of the optical system, and is a display of an item (focus guide) indicating a moving direction of the focus position of the optical system for focusing on the object as illustrated in FIG. 5G. The focus guide is superimposed on the captured image. In FIG. 5G, the focus guide includes three triangles and one guide frame. The focus guide can take a plurality of display forms as illustrated in FIG. 7. The display form of the focus guide indicates the moving direction and a moving amount of the focus position for focusing on the object at a guide frame position.

In step S607, the system control unit 50 determines whether or not the adjustment mode (currently set adjustment mode) is the focus difference adjustment mode. In a case where the system control unit 50 determines that the adjustment mode is the focus difference adjustment mode, the processing proceeds to step S608, and otherwise, the processing proceeds to step S611. The determination in step S607 is, for example, determination as to whether or not the adjustment mode change switch 304 is positioned at the position 311.

In step S608, the system control unit 50 determines whether or not both the right image region and the left image region are displayed in the fish-eye format. In a case where the system control unit 50 determines that both the right image region and the left image region are displayed in the fish-eye format, the processing proceeds to step S611, and otherwise, the processing proceeds to step S609.

In step S609, the system control unit 50 determines whether or not the enlargement and display of the right image region are performed. In a case where the system control unit 50 determines that the enlargement and display of the right image region are performed, the processing proceeds to step S614, and otherwise, the processing proceeds to step S610. The determination in step S609 may be interpreted as determination as to whether or not the right image region is displayed without displaying the left image region.

In step S610, the system control unit 50 determines whether or not the enlargement and display of the left image region are performed. In a case where the system control unit 50 determines that the enlargement and display of the left image region are performed, the processing proceeds to step S617, and otherwise, the focus adjustment processing is ended. The determination in step S610 may be interpreted as determination as to whether the left image region is displayed without displaying the right image region.

Thereafter, as described in steps S611, S612, S614, S615, S617, and S618, the system control unit 50 performs different focus adjustment processing in accordance with the adjustment mode and the display state. FIG. 8 illustrates a correspondence relationship between a combination of the adjustment mode and the display state and the focus adjustment processing.

In step S611, the system control unit 50 determines whether or not the focus ring 320 is turned (whether or not a focus adjustment instruction is issued). In a case where the system control unit 50 determines that the focus ring 320 is turned, the processing proceeds to step S612, and otherwise, the processing proceeds to step S613.

In step S612, the system control unit 50 drives both the right optical system 301R and the left optical system 301L to perform both the focus adjustment of the right optical system 301R and the focus adjustment of the left optical system 301L. Here, a change amount and a change direction of the focus position are determined in accordance with a rotation amount and a rotation direction of the focus ring 320. For example, the larger the rotation amount of the focus ring 320, the larger the change amount of the focus position. In addition, whether the focus position changes in an infinity direction or a near direction is determined in accordance with whether or not the focus ring 320 is turned clockwise or counterclockwise. The system control unit 50 moves the focus position of the right optical system 301R and the focus position of the left optical system 301L in the same moving direction by the same moving amount.

In step S613, the system control unit 50 performs display that is set to be enabled between the MF peaking display and the MF indicator display. In a case where the MF peaking display is set to be enabled, the MF peaking display corresponding to the right image region and the MF peaking display corresponding to the left image region are performed. In a case where the MF indicator display is set to be enabled, the MF indicator display corresponding to the right image region is performed, and the MF indicator display corresponding to the left image region is performed.

In the MF peaking display corresponding to the right image region, the contour of the focusing region in the right image region is emphasized, and in the MF peaking display corresponding to the left image region, the contour of the focusing region in the left image region is emphasized. In the MF indicator display corresponding to the right image region, an item indicating a distance from the camera 100 to the focus position of the right optical system 301R is displayed, and an item indicating a distance from the camera 100 to the focus position of the left optical system 301L is displayed.

However, when the right image region is not displayed, the MF peaking display corresponding to the right image region and the MF indicator display corresponding to the right image region are not performed. Similarly, when the left image region is not displayed, the MF peaking display corresponding to the left image region and the MF indicator display corresponding to the left image region are not performed.

In step S614, the system control unit 50 determines whether or not the focus ring 320 is turned (whether or not the focus adjustment instruction is issued). In a case where the system control unit 50 determines that the focus ring 320 is turned, the processing proceeds to step S615, and otherwise, the processing proceeds to step S616.

In step S615, the system control unit 50 performs the focus adjustment of the right optical system 301R without performing the focus adjustment of the left optical system 301L. For example, the system control unit 50 drives only the right optical system 301R without driving the left optical system 301L (without moving the focus position of the left optical system 301L) to move only the focus position of the right optical system 301R. The system control unit 50 may move the focus position of the right optical system 301R and the focus position of the left optical system 301L in the same moving direction by the same moving amount by driving both the right optical system 301R and the left optical system 301L. Thereafter, the system control unit 50 may return the focus position of the left optical system 301L to an original position by driving only the left optical system 301L in a reverse direction. Only the focus adjustment of the right optical system 301R may be performed by another method.

In step S616, the system control unit 50 performs display that is set to be enabled between the MF peaking display and the MF indicator display. In a case where the MF peaking display is set to be enabled, the MF peaking display corresponding to the left image region is not performed, and the MF peaking display corresponding to the right image region is performed. In a case where the MF indicator display is set to be enabled, the MF indicator display corresponding to the left image region is not performed, and the MF indicator display corresponding to the right image region is performed. However, when the right image region is not displayed, the MF peaking display corresponding to the right image region and the MF indicator display corresponding to the right image region are not performed.

In step S617, the system control unit 50 determines whether or not the focus ring 320 is turned (whether or not the focus adjustment instruction is issued). In a case where the system control unit 50 determines that the focus ring 320 is turned, the processing proceeds to step S618, and otherwise, the processing proceeds to step S619.

Similarly to step S612, in step S618, the system control unit 50 performs both the focus adjustment of the right optical system 301R and the focus adjustment of the left optical system 301L. The system control unit 50 may display the warning guide A on the display unit 108 simultaneously with the focus adjustment, before the focus adjustment, or after the focus adjustment. As described above, the warning guide A is displayed in order to suppress the user's confusion.

In step S619, the system control unit 50 performs display that is set to be enabled between the MF peaking display and the MF indicator display. In a case where the MF peaking display is set to be enabled, the MF peaking display corresponding to the right image region is not performed, and the MF peaking display corresponding to the left image region is performed. In a case where the MF indicator display is set to be enabled, the MF indicator display corresponding to the right image region is not performed, and the MF indicator display corresponding to the left image region is performed. However, when the left image region is not displayed, the MF peaking display corresponding to the left image region and the MF indicator display corresponding to the left image region are not performed.

In step S620, the system control unit 50 determines whether or not both the right image region and the left image region are displayed in the fish-eye format. In a case where the system control unit 50 determines that both the right image region and the left image region are displayed in the fish-eye format, the processing proceeds to step S622, and otherwise, the processing proceeds to step S621. In a case where the focus guide display is set to be disabled, the system control unit 50 may end the focus adjustment processing without proceeding to step S621 or step S622.

In step S621, the system control unit 50 displays the focus guide in the displayed image region. When the right image region is displayed, the focus guide is displayed in the right image region, and when the left image region is displayed, the focus guide is displayed in the left image region. The display position of the guide frame of the focus guide is designated by, for example, a touch operation on the display unit 108 by the user.

In step S622, the system control unit 50 displays the focus guide in one of the right image region and the left image region. For example, in a case where a position in the right image region is designated by a user's touch operation or the like, the focus guide is displayed at the designated position (position in the right image region). Similarly, in a case where a position in the left image region is designated by a user's touch operation or the like, the focus guide is displayed at the designated position (position in the left image region). The method of determining the image region in which the focus guide is displayed is not limited thereto, and for example, the focus guide may be constantly displayed in the right image region regardless of whether the position designated by the user is in the right image region or the left image region. In this case, in a case where the position in the left image region is designated by a user's touch operation or the like, a guide frame of the focus guide may be displayed at a position in the right image region corresponding to the designated position (touch position). The image region in which the focus guide is displayed may be selected in accordance with the adjustment mode. In the focus difference adjustment mode, the focus guide may be displayed in the right image region regardless of the touch position, and in the focus adjustment mode, the focus guide may be displayed in the image region including the touch position.

Note that, instead of the processing of steps S617 and S618, the processing of steps S623 and S624 or the processing of steps S625 and S626 may be performed.

In step S623, the system control unit 50 determines whether or not the focus ring 320 is turned (whether or not the focus adjustment instruction is issued). In a case where the system control unit 50 determines that the focus ring 320 is turned, the processing proceeds to step S624, and otherwise, the processing proceeds to step S619.

In step S624, the system control unit 50 performs the focus adjustment of the left optical system 301L without performing the focus adjustment of the right optical system 301R. As described in step S615, various methods may be used as the method of performing only the focus adjustment of one optical system.

The processing of steps S623 and S624 is performed in a state where the left image region is enlarged and displayed without displaying the right image region. The processing of steps S623 and S624 is performed, and thus, the focus position of the right optical system 301R (the optical system in which the image region is not displayed) can be prevented from being moved to an unintended focus position.

In a case where the processing of steps S623 and S624 is performed, only the focus adjustment of the left optical system 301L may be performed, and the warning guide B may be displayed on the display unit 108. FIG. 5H illustrates an example of the warning guide B. The warning guide B in FIG. 5H is a guide indicating that only the focus adjustment of the optical system corresponding to the displayed image region is performed in accordance with the rotation of the focus ring 320 during the enlargement and display of one of the right image region and the left image region. As a result, for example, it is possible to notify the user that the focus adjustment changes between a case where both the right image region and the left image region are displayed and a case where only one image region thereof is displayed.

In step S625, the system control unit 50 determines whether or not the focus ring 320 is turned (whether or not the focus adjustment instruction is issued). In a case where the system control unit 50 determines that the focus ring 320 is turned, the processing proceeds to step S626, and otherwise, the processing proceeds to step S619.

In step S626, the system control unit 50 displays a warning guide C on the display unit 108 without performing the focus adjustment of the right optical system 301R or the focus adjustment of the left optical system 301L. FIG. 5I illustrates an example of the warning guide C. The warning guide C is an item corresponding to that neither the focus adjustment of the right optical system 301R nor the focus adjustment of the left optical system 301L is performed. The warning guide C in FIG. 5I indicates a situation in which the focus adjustment cannot be performed, and prompts switching to the enlargement and display of the right image region.

Note that, in a case where the processing of steps S625 and S626 is performed, the system control unit 50 ends the focus adjustment processing without performing the processing of steps S619 to S622.

The processing of steps S625 and S626 is performed, and thus, even in a case where only the focus adjustment of the left optical system 301L cannot be performed, the focus position of the right optical system 301R (the optical system in which the image region is not displayed) can be prevented from being moved to an unintended focus position.

As described above, according to the present embodiment, it is possible to suppress focus adjustment unintended by the user. For example, it is possible to suppress a situation in which only the focus position of the right optical system 301R changes in a state where the right image region is not displayed.

Note that, in the above description, the situation in which “the focus adjustment is not performed” may be a situation in which the focus adjustment is suppressed as compared with the situation in which “the focus adjustment is performed”, and the focus position may be moved by a smaller moving amount than in the situation in which “the focus adjustment is performed”. The situation in which “the focus position is not moved” may be a situation in which the movement of the focus position is suppressed as compared with the situation in which “the focus position is moved”, and the focus position may be moved by a smaller moving amount than in the situation in which “the focus position is moved”. For example, in step S615, the focus position of the left optical system 301L may be moved by a smaller moving amount, and the focus position of the right optical system 301R may be moved by a larger moving amount. In step S626, at least one of the focus position of the right optical system 301R and the focus position of the left optical system 301L may be slightly moved.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

For example, the right optical system 301R and the right image region in the above description may be replaced with the left optical system 301L and the left image region, and the left optical system 301L and the left image region in the above description may be replaced with the right optical system 301R and the right image region. Two optical systems or three or more optical systems arranged in a direction (up-and-down direction or oblique direction) other than the left-right direction may be used.

There may be a display state other than the three display states of a state where both the right image region and the left image region are displayed in the fish-eye format, a state where the enlargement and display of the right image region are performed, and a state where the enlargement and display of the left image region are performed.

For example, as illustrated in FIG. 5J, there may be a parallel enlargement and display state where a left enlargement region obtained by enlarging a part of the left image region and a right enlargement region obtained by enlarging a part of the right image region are displayed side by side. The display state may transition to the parallel enlargement state in accordance with a touch on a touch button different from the enlargement touch button 503. In a case where the focus difference adjustment mode is in the parallel enlargement and display state, the processing proceeds to, for example, step S611.

As illustrated in FIG. 5K, there may be a right two-window display state where the right image region in the fish-eye format and the right enlargement region are displayed side by side. The user operation for the transition to each display state is not particularly limited, and the user operation for the transition to the right two-window display state is also not particularly limited. In a case where the focus difference adjustment mode is in the right two-window display state, the processing proceeds to, for example, step S614. Similarly, there may be a left two-window display state.

The “display in the fish-eye format” in the above description may be another display such as “equirectangular display”.

A state where both the right image region and the left image region are displayed in the fish-eye format may be interpreted as a state where both the right image region and the left image region are displayed. A state where the enlargement and display of the right image region are performed may be interpreted as a state where the right image region is displayed without displaying the left image region. A state where the enlargement and display of the left image region are performed may be interpreted as a state where the left image region is displayed without displaying the right image region.

In step S608, in a case where the system control unit 50 determines that both the right image region and the left image region are displayed in the fish-eye format, the processing may proceed to step S614. In this way, the user can adjust the focus difference while comparing the right image region and the left image region in the same screen. When the focus adjustment mode is selected by the adjustment mode change switch 304, both the focus adjustment of the right optical system 301R and the focus adjustment of the left optical system 301L can be performed simultaneously.

The display related to the focus position of the optical system is not limited to the MF peaking display, the MF indicator display, and the focus guide display. As the display related to the focus position of the optical system, one type of display may be performed, two types of display may be performed, or four or more types of display may be performed.

The user operation for the focus adjustment instruction is not limited to the rotation of the focus ring 320. For example, the user operation for the focus adjustment instruction may be a touch operation (swipe operation or the like) on a screen of a smartphone or the like wirelessly connected to the camera 100. The user operation for the focus adjustment instruction may be a keyboard operation on a personal computer wirelessly connected to the camera 100.

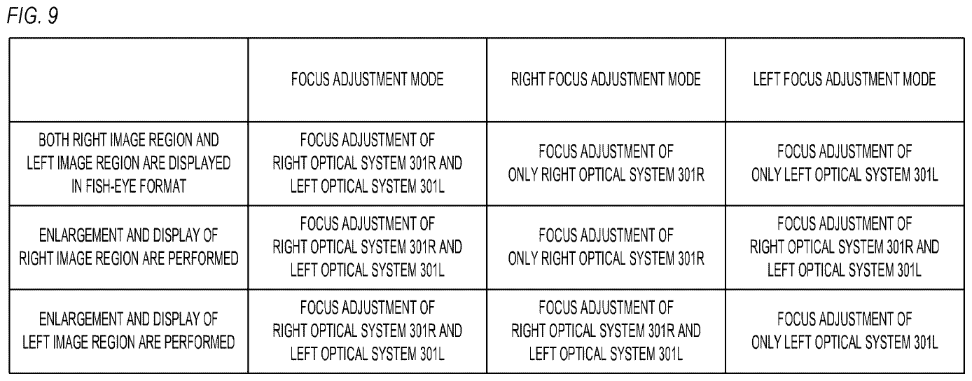

The adjustment mode is not limited to the focus adjustment mode and the focus difference adjustment mode. There may be three or more types of adjustment modes. For example, as illustrated in FIG. 9, there may be a focus adjustment mode, a right focus adjustment mode, and a left focus adjustment mode.

In addition, although an example in a case where the present disclosure is applied to the digital camera has been described, the present disclosure is not limited to the digital camera, and can be applied to any electronic device capable of acquiring a captured image. For example, the present disclosure can be applied to a personal computer, a PDA, a mobile phone terminal, a portable image viewer, a printer apparatus, a digital photo frame, a music player, a game machine, an electronic book reader, and the like. In addition, the present disclosure can be applied to a video player, a display apparatus (including a projection apparatus), a tablet terminal, a smartphone, an AI speaker, a home appliance, an in-vehicle apparatus, and the like. The present disclosure is also applicable to an imaging apparatus and is also applicable to an external device of the imaging apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-198867, filed Nov. 14, 2024, which is hereby incorporated by reference herein in its entirety.

What is claimed is:

1. An electronic device comprising:
a processor; and
a memory storing a program which, when executed by the processor, causes the electronic device to
execute acquisition processing of acquiring an image including a first image region captured via a first optical system and a second image region captured via a second optical system,
execute display control processing of performing control such that the image is displayed, and
execute control processing of performing control such that focus adjustment is performed in accordance with a focus adjustment instruction,
wherein, in a case where the focus adjustment instruction is issued in a state where the second image region is displayed without displaying the first image region, in the control processing, control is performed such that focus adjustment of the first optical system and focus adjustment of the second optical system are performed.

2. The electronic device according to claim 1,
wherein, in a case where the focus adjustment instruction is issued in a state where the second image region is displayed without displaying the first image region, in the control processing, control is performed such that a focus position of the first optical system and a focus position of the second optical system are moved in a same moving direction by a same moving amount.

3. An electronic device comprising:
a processor; and
a memory storing a program which, when executed by the processor, causes the electronic device to
execute acquisition processing of acquiring an image including a first image region captured via a first optical system and a second image region captured via a second optical system,
execute display control processing of performing control such that the image is displayed, and
execute control processing of performing control such that focus adjustment is performed in accordance with a focus adjustment instruction,
wherein, in a case where the focus adjustment instruction is issued in a state where the second image region is displayed without displaying the first image region, in the control processing, control is performed such that focus adjustment of the first optical system is suppressed.

4. The electronic device according to claim 3,
wherein, in a case where the focus adjustment instruction is issued in a state where the second image region is displayed without displaying the first image region, in the control processing, control is performed such that focus adjustment of the first optical system is suppressed and focus adjustment of the second optical system is performed.

5. The electronic device according to claim 4,
wherein, in a case where the focus adjustment instruction is issued in a state where the second image region is displayed without displaying the first image region, in the control processing, control is performed such that movement of a focus position of the first optical system is suppressed and a focus position of the second optical system is moved.

6. The electronic device according to claim 4,
wherein, in a case where the focus adjustment instruction is issued in a state where the second image region is displayed without displaying the first image region, in the control processing, control is performed such that a focus position of the first optical system is returned to an original position after the focus position of the first optical system and a focus position of the second optical system are moved in a same moving direction.

7. The electronic device according to claim 3,
wherein, in a case where the focus adjustment instruction is issued in a state where the second image region is displayed without displaying the first image region, in the control processing, control is performed such that focus adjustment of the first optical system and focus adjustment of the second optical system are suppressed.

8. The electronic device according to claim 7,
wherein, in a case where the focus adjustment instruction is issued in a state where the second image region is displayed without displaying the first image region, in the display control processing, control is performed such that an item corresponding to the suppression of the focus adjustment of the first optical system and the suppression of the focus adjustment of the second optical system is displayed.

9. The electronic device according to claim 3,
wherein, in the display control processing, in a case where the focus adjustment instruction is issued,
control is performed such that
display related to a focus position of the first optical system is performed in a case where the first image region is displayed and focus adjustment of the first optical system is performed, and
the display related to the focus position of the first optical system is not performed in a case where focus adjustment of the first optical system is suppressed.

10. The electronic device according to claim 9,
wherein the display related to the focus position of the first optical system includes display that emphasizes a contour of a focusing region in the first image region.

11. The electronic device according to claim 9,
wherein the display related to the focus position of the first optical system includes display of an item indicating a distance from an imaging device that captures the image to the focus position of the first optical system.

12. The electronic device according to claim 9,
wherein the display related to the focus position of the first optical system includes display of an item indicating a moving direction of the focus position of the first optical system for focusing on an object.

13. A control method of an electronic device, comprising:
acquiring an image including a first image region captured via a first optical system and a second image region captured via a second optical system,
performing control such that the image is displayed, and
performing control such that focus adjustment is performed in accordance with a focus adjustment instruction,
wherein, in a case where the focus adjustment instruction is issued in a state where the second image region is displayed without displaying the first image region, control is performed such that focus adjustment of the first optical system and focus adjustment of the second optical system are performed.

14. A control method of an electronic device, comprising:
acquiring an image including a first image region captured via a first optical system and a second image region captured via a second optical system,
performing control such that the image is displayed, and
performing control such that focus adjustment is performed in accordance with a focus adjustment instruction,
wherein, in a case where the focus adjustment instruction is issued in a state where the second image region is displayed without displaying the first image region, control is performed such that focus adjustment of the first optical system is suppressed.

15. A non-transitory computer readable medium that stores a program, wherein the program causes a computer to execute the control method according to claim 13.

16. A non-transitory computer readable medium that stores a program, wherein the program causes a computer to execute the control method according to claim 14.
